(19) United States
(12) Patent Application Publication
(10) Pub. No.: US 2015/0275666 A1
(43) Pub. Date: Oct. 1, 2015

(54) Device and method for determining at least one parameter, which determines the application of sprayed concrete

(71) Applicant: ATLAS COPCO ROCK DRILLS AB, Örebro (SE)

(72) Inventors: Otto Tschumi, Frauenfeld (CH); Tobias Rauber, Langnau am Albis (CH); Reik Winkel, Aachen (DE)

(73) Assignee: ATLAS COPCO ROCK DRILLS AB, Orebro (SE)

(21) Appl. No.: 14/433,793

(22) PCT Filed: Sep. 27, 2013
(86) PCT No.: PCT/SE2013/000149

§ 371 Date: Apr. 6, 2015

Related U.S. Application Data
(60) Provisional application No. 61/710,002, filed on Oct. 5, 2012.

(30) Foreign Application Priority Data
Oct. 5, 2012 (EP) 12187373.1

(51) Int. Cl. E21D 11/10; B05B 12/12; B05D 1/02; B05B 12/08

(52) U.S. Cl. CPC E21D 11/10; B05B 12/084; B05B 12/124; B05D 1/02

(57) ABSTRACT

A device for applying sprayed concrete to surfaces during tunnel construction and mining. The device includes a radar system including at least one radar sensor that is arranged on a circumference around a spray nozzle. A method for determining at least one parameter that determines the application of sprayed concrete to surfaces during tunnel construction and mining.

The present invention relates to a device for applying sprayed concrete to surfaces during tunnel construction and mining, which device is equipped with a radar system composed of at least one radar sensor which is arranged on the circumference around the spray nozzle, and to a method for determining at least one parameter which determines the application of sprayed concrete to surfaces during tunnel construction and mining.

In order to perform rock stabilization of a tunnel blasting round, in order to form a lining coating and for insulation purposes, a coating of sprayed concrete is applied to the inner wall of a tunnel during structural work. A tunnel blasting round is understood here to be the free space which is broken out of a rock by exploding or milling. A tunnel wall surface which is to be coated with sprayed concrete is generally of a very irregular condition. Various properties of a concrete coating which is applied to the wall inner surface of a tunnel or gallery determine the quality of the concrete.

Spray nozzles for the purpose of outputting compositions which usually contain cement but also of other types such as, for example, sprayed concrete or polymer systems are usually equipped with a device for metering a fluid into the mixture. In what is referred to as the “dry method” in which a dry mixture is fed to the spray nozzle, the fluid is mainly composed of water, frequently with additives which are dissolved or dispersed therein. In the case of “wet methods” in which a wet mixture, to which water has already been added, is fed to the spray nozzle, the fluid is generally a solution or dispersion of additives.

Radar devices emit electromagnetic waves in the MHz up to GHz range by means of a transmission antenna and receive the echoes reflected from an object by means of a reception antenna. The received radar signals can be evaluated according to various criteria in order, as a result, to obtain information about the object.

Radar sensors are already used in numerous industrial applications such as for measuring the filling level of a silo or in collision prevention applications.

U.S. Pat. No. 6,246,359 B1 describes a radar device which comprises a multiplicity of sequentially connected transmitter antennas each with differently directed radiation lobes, as well as two reception antennas which are arranged one next to the other and are offset from the transmission antennas, for the purpose of receiving the reflected transmission signals, and a device for detecting the azimuthal direction on the basis of the phase difference and/or amplitude difference between the received reflected transmission signals.

A further example of a radar device is described in JP 63-141674. In order to determine the position of the spray nozzles, an ultrasound-propagating sensor is arranged around the spray nozzle, which sensor determines the distance or the angle of the spray.

DE 10 2004 034 429 B4 describes what is referred to as a radar front-end device for automobile applications which is suitable for detecting short and also medium and/or large distances. As a result of the provision of the radar front-end, the range in front of a vehicle is mapped so well, in particular over a few vehicle lengths and up to an average distance of, for example, at least 30 m by means of radar, that all the conceivable road users and obstacles can be detected clearly even in complex scenarios and their position can be determined in a two-dimensional fashion with a good resolution.

When sprayed concrete is applied in tunnels and in mine galleries, the three-dimensional initial surface is measured, scanned and documented and the thickness of the concrete coating which is to be applied is determined. The 3D information about the surface which is to be coated permits the correct nozzle distance from the surface and optimum impact angle of 90° to be maintained as well as possible. As a result, the quality of the applied concrete coating is correlated. Modern application technology makes it possible for the quality of the surface which is to be coated no longer to be determined solely visually by the operator but also supported by sensors. This problem has been solved by sensing the surface with a laser scanner before and after the spraying. The difference which is determined corresponds to the thickness of the concrete coating which is applied.

Owing to the problems described below, this technology has only become established to a limited degree: 1. The scanning process lasts too long and the operator cannot pursue any other activity during the scanning process. 2. Optical measuring devices are not sufficiently robust for the application in the tough environment of mining and are very susceptible to soiling and moisture.

An alternative sensor system based on ultrasound is sensitive to mining influences. A loss of signal therefore occurs due to attenuation (dust), due to drifting (weather conditions, wind, spray jet) or else due to extraneous noises (filling, engines etc.) being superimposed. The signal can also be lost, or measuring errors can also occur, due to interference from sensors in the vicinity. Fluctuating measuring errors of several percent arise due to fluctuating environmental conditions (such as temperature, air pressure underground). Static measuring errors result due to inaccurate or absent in-situ calibration (meters above sea level or air pressure underground).

The present invention was based on the object of substantially avoiding at least some of the disadvantages of the prior art presented above. In particular, there was the need to measure parameters such as initial topography, nozzle distance, impact angle and applied thickness of coating during the spraying process and to record them and to use robotic applications for the control circuit.

Furthermore, in the case of a concrete coating which has already been applied and which becomes detached from the surface of rubble and is at risk of falling down or has already broken out, there is a need to subject this concrete coating to a scanning process before and after the renewed application. It would also be highly advantageous to be able to repair rock falls in the manual spraying mode and in the process record the correction process with a real-time measuring system.

The problems mentioned above have been solved with the features of the independent claims. The dependent claims relate to preferred embodiments.

The subject matter of the present invention is therefore a device for applying sprayed concrete to surfaces during tunnel construction and mining, wherein the spray head comprises a spray nozzle and a radar system with at least one radar sensor which is arranged on the circumference around the spray nozzle, with the purpose of measuring the distance between the spray head and the rock mass.

The radar sensor emits electromagnetic waves which are reflected by the object to be detected and sensed by the sensor. The extent and the quality of the reflection is determined by material from which the object is composed.

In one preferred embodiment of the invention, each radar sensor comprises: a radar module, an evaluation unit with a digital signal processor and a combined transmission and reception antenna. In this context, the radar module measures the distance from the surface by emitting radar waves and evaluating the wave reflection. The antenna focuses the measuring range.

In the present case of the invention, a special radar sensor is preferably used which carries out very rapid measurements >>1 Hz (10-1000 Hz). In addition, both polarization directions (vertical/horizontal) are measured separately from one another. The additional information can be used to characterize the material of the reflecting surface or to better filter out interference echoes. In addition it is possible to adjust the measuring device via phase controllers or to perform digital beam forming so that less interference occurs as a result of the jet of sprayed concrete.

It is advantageous for the device according to the invention that the radar system is additionally equipped with at least one unit for determining the relative position of the spray nozzle with respect to the vehicle coordinate system. In this context, the vehicle coordinate system is again in a relationship with the environment coordinate system of the rock mass. It is therefore possible to determine the orientation and the position of the spray head in relation to the zero point of the vehicle. As a result, oscillations of the nozzle head which are superimposed on the radar signals are removed by calculation. The determination of the position of the nozzle can be carried out by means of the manipulator sensor system (angle and length pickup), wherein the correction of oscillations of the spray head is preferably carried out by means of an inertial measuring unit (IMU) in the spray head. Furthermore, the time relationship between the inertial measuring unit and the radar distance measurement can be utilized. By measuring the offset of the measuring point and the orientation thereof over time in space it is possible to place the distance values which are sensed in chronological succession in a spatial relationship with one another. This permits angle correction of the measuring direction with respect to the wall, and as a result of the overlapping of the measuring surfaces of closely adjacent measurements it is possible to combine these measurements with one another, as a result of which a higher resolution is obtained.

Within the device according to the invention, in order to determine the position of the spray nozzle in a stable fashion, the device comprises an inertial measuring unit at least one component from the series 3D acceleration sensor, inclination sensor, rotational speed sensor, gyroscope and compass.

As an alternative, the determination of the position of the spray head can also take place by means of active transponders (microwaves, millimetre waves, ultrasound) which can be located at a distance or even at an angle of one or more base stations. This means that the following are measured a): how far the transponder is from the reading device/base station (distance in meters) and b): what direction the transponder is located in with respect to the main emission direction of the reading antenna.

In one particularly preferred embodiment, the spray head comprises a radar system with more than three, preferably four or six, radar sensors, which are preferably arranged concentrically around the spray nozzle.

In addition to the device itself, the present invention also comprises a method for determining at least one parameter within the scope of the application of sprayed concrete to surfaces during tunnel construction and mining, wherein the method is carried out using the device according to the invention which is described above. In this context, the at least one parameter is selected from the series: coating thickness of the applied sprayed concrete, distance between the spray head and the surface to be coated, impact angle as a vector with respect to the surface to be coated and/or 3D profile of the surface to be coated during and/or after the application of the sprayed concrete, surface geometry during the spraying process, and geometry of the applied concrete coating after the application thereof.

According to one preferred embodiment, the invention comprises a method in which, within the scope of the spray head being moved past the surface in all directions of movement using the radar sensors, the distance between the spray head and the surface before and after the application of the sprayed concrete is determined, and the thickness of the coating of the applied quantity of concrete per unit of surface area is obtained from the difference.

The thickness of the coating is determined here by chronologically offset measurements of various radar sensors at the same location. As a result of the arrangement of, for example, six radar sensors (360°/6=60° angular intervals) and a linear movement of the spray head over the surface, a point is moved over twice. “Linear” means in the present case horizontal, vertical or diagonal: it is important that the movement path does not have a “bend”, that is to say the positions of the spray head lie on a line over time.

In one arrangement of the sensors in a radius of 0.5 m around the spray nozzle and with a movement speed of 0.5 m/s, the two measurements are two seconds apart (2×radius/speed). By converting the data into a 3D model by means of the sensing of the position of the spray head it is possible to determine thicknesses of the coating even in the case of nonlinear spray paths.

In particularly preferred alternative embodiments of the method according to the invention, either all the radar sensors are attached immovably to the spray head or all the radar sensors synchronously carry out the nutation movements of the spray nozzle. In this context, the variant with radar sensors which are attached immovably to the spray head differs mainly in that the measurement before and after the application of the sprayed concrete takes place by virtue of the fact that the nutating jet of sprayed concrete moves through the measuring ranges of the radar sensors. As a result, at the cost of alternating availability of the individual sensors the time offset of the measurements of various sensors is reduced by means of a relatively small arrangement radius. It is to be considered particularly advantageous that the acquired data relating to the automatic guidance of the nozzle can be used for the spraying process. As a result, the efficiency of the automated sprayed concrete application can substantially increased since the application no longer takes place “blind” but instead the operator can react immediately on the basis of the direct feedback of the actual state. In this way, by means of the synchronous comparison of the data from all the radar sensors it is possible to determine the angle of the spray jet with respect to the surface. By means of a control circuit, this angle can be automatically set to 90° in order to reduce the portion of rebound quantities of the sprayed concrete (wastage of material and time).

In one preferred embodiment of the invention of the method, preferably during the application of the sprayed concrete, the radar beam of each radar sensor can be oriented with a conical shape with an angle of aperture in the range from 1 to 10°, and preferably of approximately 6° in all directions. More precise focusing is possible when significantly larger antennas are used. Polytetrafluoroethylene is preferably selected as a lens material since it causes little attenuation and virtually no soiling. However, lenses made of other plastics such as, for example, polycarbonate are basically also suitable.

In one particular embodiment, before the application of sprayed concrete, the radar sensors are used to determine the geometry of the tunnel/cavity. This can be done by rotating (“pivoting”) the spray head around the longitudinal axis of the tunnel while simultaneously performing telescoping. As a result of the sensor system for determining the relative position with respect to the vehicle coordinate system it is possible to map all the measurement points in a 2D or 3D model. This can then be used for rough planning of the locomotion, the said locomotion also being more precise and being adapted by the measurements during the spraying process.

In one particular preferred embodiment of the method, the dynamic distance between the spray head and the surface to be coated is ideally 0.7-2.0 m. As a result of this, the dynamic measuring range of the radar sensors can be set freely between 0 and 25 m, wherein a range between 0 and 15 m is to be considered preferable.

The present method in combination with the device according to the invention permits distance measurement of the spray nozzle arrangement by means of 4 or 6 radar sensors which are arranged in a concentric ring around the spray nozzle. Each individual radar sensor is used to determine its specific distance from the wall at its individual measuring point on the annular path. The radar sensors can determine the distance simultaneously or sequentially. The distance data can consequently be transmitted automatically to a computing unit on the spraying manipulator vehicle, or the computing unit retrieves the data. In the case of sequential measurement, in total up to 500 measured values per second are available by means of all the radar sensors. Given a configuration with a parallel measurement, up to 500 measured values are available per radar sensor.

The radar-based measuring method is based on a coherent ramp-based FMCW (frequency-modulated continuous wave”) method in a monostatic antenna configuration and a polarimetric evaluation. The available measuring bandwidth can be selected in the range between 1 GHz and 10 GHz. A large measuring bandwidth is a significant factor for the selectivity of the radar sensor if a plurality of targets are detected. The selectivity corresponds to half the wavelength of the measuring bandwidth f_{B} used. For example in the case of 5 GHz, the selectivity corresponds to a measuring object distance of approximately 3.3 cm.

During the measurement, the transmission frequency of the radar sensor is increased continuously in a ramp-like fashion symmetrically about a centre frequency f₀ of f₀−f_{B}/2 to f₀+f_{B}/2. The transmitted signal is reflected back from the measured object lying inside the measuring range, and is received. The difference between the current transmission frequency and the reception frequency is proportional to twice the distance between the measuring point and the measured object, in the present case of the wall of the tunnel.

In a length-determining algorithm which occurs after the measurement, initially what are referred to as distance gates are defined as a multiple of the selectivity interval. In the present case, these are, for example 1024 distance gates. In the case of 5 GHz bandwidth for example, a distance gate corresponds to approximately 3.3 cm. The maximum measurable distance is therefore approximately 34 m. In order to be able to determine precisely the location of an individual target within a distance gate, the phase position of the measuring frequency can be used. In the present case, said phase position is determined algorithmically to approximately 0.5° accuracy. In the present example, this results in a resolution of approximately 0.1 mm.

The measuring accuracy of the radar method depends here, on the one hand, on the material properties of the reflector material and, on the other hand, on the surface which reflects the radar signal back to the antenna. Given a lens antenna with a 6° angle of aperture, this corresponds, for example at a distance of approximately 1 m, to a surface with a diameter of approximately 5 cm. In the present measuring method, all unevennesses which are smaller than the selectivity of the measurement are averaged in the process.

Furthermore, the measuring accuracy can be increased either by using an antenna with high directivity with, for example, a 1.5° angle of aperture and/or by further signal processing with what are referred to as “superresolution” algorithms such as, for example, the MUSIC (Multiple Signal Classification) or ESPRIT (estimation of signal parameters by rotational invariance techniques) method. These algorithms are firstly mentioned in R. O. Schmidt, “Multiple emitter location and signal parameter estimation,” IEEE Trans. Antennas Propagat., vol. AP-34, pp. 276280, March 1986, as well as in Rao R'Paulraja'Kailath T ESPRIT-A Sunspace Rotation Approach to Estimation of Parameters of Simusoid in Noise[J]. IEEE Trans Acoust Speech Signal Processing ‘1986’ ASSP Vol 34, pp 1340-1342.

Further advantages of the invention are, in a non-exhaustive enumeration: the quality of the guidance of the nozzle can be measured and recorded. The quality of the guidance of the nozzle can be improved substantially both by the machine operator and by the robot on the basis of the real-time feedback with respect to the sprayed concrete parameters mentioned in the introduction. The user-friendliness of the concrete spraying device can therefore be significantly improved. The working safety of the machine operator (nozzle apparatus) can be significantly improved as they no longer have to rely solely on their visual feedback and they can therefore maintain a larger distance from the hazardous zone of the fresh blasting round.

The device according to the invention will be explained in more detail with reference to the drawing.

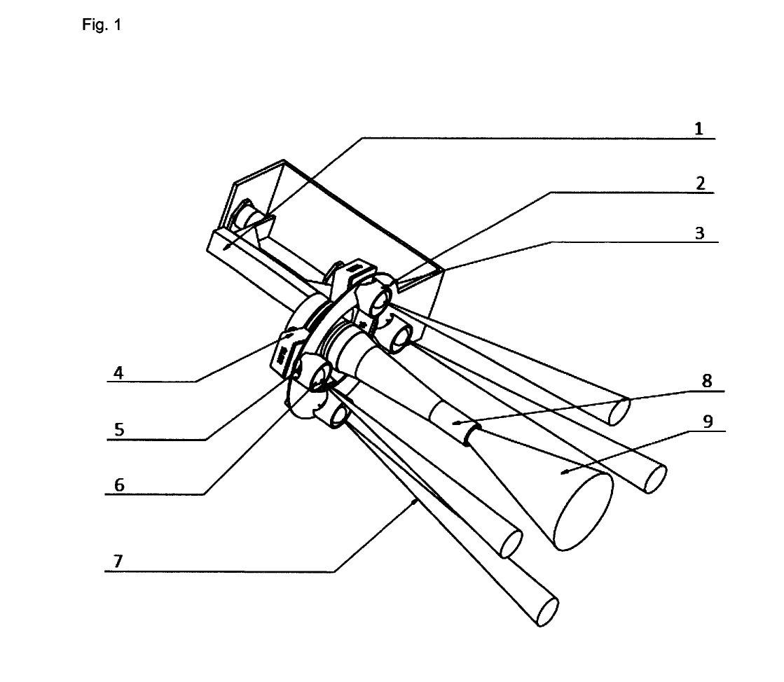

FIG. 1 shows a schematic, three-dimensional side view of a preferred embodiment of the device according to the invention during a working process composed of a radar system comprising a spray arm rig with a spray head (1), a carrier ring (2), a protective ring (3), a radar sensor (4), a clamping flange (5), an antenna (6), a radar lobe (7) (measuring range), a spray nozzle (8) and a jet of sprayed concrete (9).

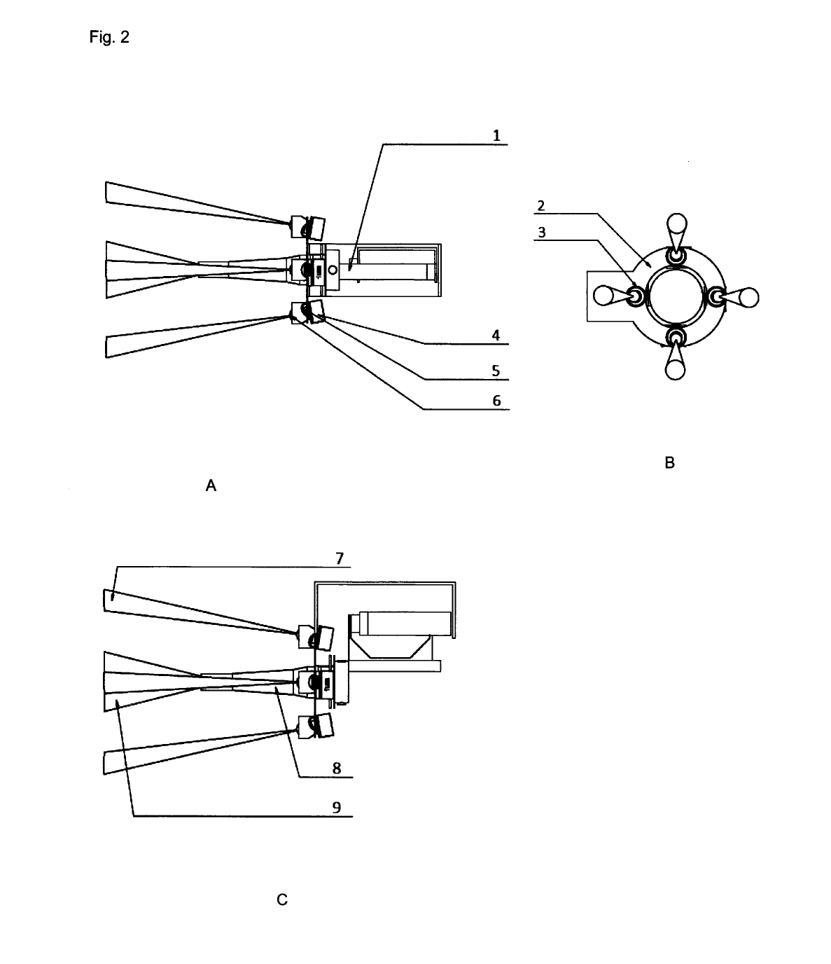

FIG. 2 shows a schematic side view of the device according to the invention composed of a radar system A comprising a spray arm rig with a spray head (1), a radar sensor (4), a clamping flange (5) and an antenna (6), a clamping flange B, which is composed, inter alia of a carrier ring (2) and a protective ring (3), and C, which is composed of a radar lobe (measuring range) (7), of a spray nozzle (8) and a jet of sprayed concrete (9). The reference symbols A, B, C represent the 3 views in the drawing.

1. A device for applying sprayed concrete to surfaces during tunnel construction and mining, the device comprising:
a spray head comprising a spray nozzle and a radar system comprising at least one radar sensor arranged on a circumference around the spray nozzle.

2. The device according to claim 1, wherein each of the at least one radar sensor comprises a radar module, an evaluation unit with a digital signal processor and a combined transmission and reception antenna.

3. The device according to claim 1, wherein the radar system further comprises at least one unit configured to determine a relative position of the spray nozzle with respect to a vehicle coordinate system.

4. The device according to further comprising:
an inertial measuring unit configured to determine a position of the spray nozzle in a stable fashion, the inertial measuring unit comprising at least one component from the group of a 3D acceleration sensor, an inclination sensor, a rotational sensor, a gyroscope and a compass.

5. The device according to claim 1, wherein the radar system comprises four or six radar sensors arranged concentrically around the spray nozzle.

6. A method for determining at least one parameter within a scope of an application of sprayed concrete to surfaces during tunnel construction and mining, the method comprising:
selecting at least one parameter from the group of a coating thickness of the applied sprayed concrete, a distance between a spray head and a surface to be coated, an impact angle as a vector with respect to at least one of the surface to be coated or a 3D profile of the surface to be coated at least one of during or after application of the sprayed concrete, surface geometry during the spraying process or geometry of the applied concrete coating after the application thereof, wherein said method is carried out using a device comprising a spray head comprising a spray nozzle and a radar system comprising at least one radar sensor arranged on a circumference around the spray nozzle.

7. The method according to claim 6, further comprising:
determining a distance between the spray head and the surface before and after the application of the sprayed concrete by moving the spray head past the surface in all directions of movement using the radar sensors, and
obtaining the thickness of the coating of the applied quantity of concrete per unit of surface area from the difference.

8. The method according to claim 6, wherein all the radar sensors are attached immovably to the spray head.

9. The method according to claim 6, wherein all the radar sensors synchronously carry out nutation movements of the spray nozzle.

10. The method according to claim 6, further comprising:
utilizing acquired data to automatically guide the nozzle during the spraying process.

11. The method according to claim 6, further comprising:
during the application of the sprayed concrete, orienting the radar beam of each radar sensor with a conical shape with an angle of aperture in a range from 1 to 10°.

12. The method according to claim 6, wherein a dynamic distance between the spray head and the surface to be coated is 0.7-2.0 m, and as a result a dynamic measuring range of the radar sensors can be set freely between 0 and 15 m.

13. The method according to claim 6, further comprising:
determining a 2D/3D geometry of the tunnel, before the application of sprayed concrete, with the radar sensors by telescoping and pivoting the spray head.

14. The method according to claim 11, wherein the angle of aperture is 6° in all directions.

15. The method according to claim 14, wherein the radar beam of each radar sensor is oriented utilizing a polytetrafluoroethylene lens.
